(19) United States
(12) Patent Application Publication
(10) Pub. No.: US 2023/0075088 A1
(43) Pub. Date: Mar. 9, 2023

(54) SYSTEMS AND METHODS FOR REPORTING AND BEAM MANAGEMENT USING ARTIFICIAL INTELLIGENCE

(71) Applicant: ZTE CORPORATION, Shenzhen (CN)

(72) Inventors: Bo GAO, Shenzhen (CN); Zhaohua LU, Shenzhen (CN); Guozeng ZHENG, Shenzhen (CN); Zhen HE, Shenzhen (CN); Wenjun YAN, Shenzhen (CN)

(21) Appl. No.: 17/950,778

(22) Filed: Sep. 22, 2022

Related U.S. Application Data
(63) Continuation of application No. PCT/CN2021/085362, filed on Apr. 2, 2021.

(51) Int. Cl. H04L 5/00; H04W 24/10

(52) U.S. Cl. CPC H04L 5/0048; H04W 24/10

(57) ABSTRACT

Presented are systems and methods for reporting and beam management using artificial intelligence. A wireless communication device may receive a configuration for a plurality of downlink (DL) reference signals (RSs) from a wireless communication node. The wireless communication device may receive at least one of the plurality of DL RSs. The wireless communication device may send a report to the wireless communication node.

### CROSS-REFERENCE TO RELATED APPLICATION

This application claims the benefit of priority under 35 U.S.C. § 120 as a continuation of PCT Patent Application No. PCT/CN2021/085362, filed on Apr. 2, 2021, the disclosure of which is incorporated herein by reference in its entirety.

### TECHNICAL FIELD

The disclosure relates generally to wireless communications, including but not limited to systems and methods for reporting and beam management using artificial intelligence.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication device may receive a configuration for a plurality of downlink (DL) reference signals (RSs) from a wireless communication node. The wireless communication device may receive at least one of the plurality of DL RSs. The wireless communication device may send a report to the wireless communication node.

In some embodiments, the report may include a timestamp, that comprises a time instance, a time unit, a symbol index, a slot index, a subframe index, a frame index, a transmission occasion index, or an indication of a time duration relative to the time instance associated with the report. In some embodiments, at least one of: time-difference information, a Doppler shift, a Doppler spread, an average delay, a delay spread, a RS index, group information or a channel quality parameter, in the report, may be associated with or determined according to the timestamp. In some embodiments, the report may include time-difference information, that includes at least one of: time difference between receive timing and transmit timing, reference signal time difference, time difference between receive timing and reference timing, or time difference between transmit timing and reference timing. In some embodiments, the time difference between receive timing and transmit timing may be at least one of: defined from perspective of the wireless communication device, or defined as T_{UE-RX}−T_{UE-TX}, or defined as T_{UE-TX}−T_{UE-RX}. In some embodiments, T_{UE-RX} may be the receive timing in a DL time unit. In some embodiments, T_{UE-TX} may be the transmit timing in an uplink (UL) time unit.

In some embodiments, the DL time unit may refer to a time unit of receiving a DL RS from the plurality of DL RSs. In some embodiments, the UL time unit may refer to a time unit of transmitting an UL RS. In some embodiments, T_{UE-RX} may be defined by a first detected path in time or a path with strongest receive power in time. In some embodiments, the UL time unit may be closest in time to the DL time unit. In some embodiments, the reference signal time difference (RSTD) may be at least one of: defined from perspective of the wireless communication device, or defined as T_{Rxj}−T_{Rxi} or T_{Rxi}−T_{Rxj}. In some embodiments, T_{Rxj} may be a time at which the wireless communication device receives a first DL RS or one time unit corresponding to the first DL RS. In some embodiments, T_{Rxi} may be a time when at which the wireless communication device receives a second DL RS or one time unit corresponding to the second DL RS. In some embodiments, the time unit corresponding to the second DL RS may be nearest in time to the time unit corresponding to first DL RS. In some embodiments, the transmit timing may correspond to a time unit of transmitting an uplink (UL) signal. In some embodiments, the receive timing may correspond to a time unit of receiving the DL signal. In some embodiments, the reference timing may correspond to a reference time unit. In some embodiments, the time-difference information may be determined using at least one of: a mod function, a scaling factor, a reference time unit, a timing advance value, the time difference between receive timing and transmit timing, the reference signal time difference, time difference between receive timing and reference timing, or time difference between transmit timing and reference timing.

In some embodiments, the time-difference information may be determined according to one of: (the reference time unit)−(the timing advance value)+(the time difference between receive timing and transmit timing), ((the time difference between receive timing and transmit timing)−(the timing advance value)) mod (the reference time unit), (the reference time unit)−(the timing advance value)*(the scaling factor)+(the time difference between receive timing and transmit timing), or (the time difference between receive timing and transmit timing) mod (the reference time unit). In some embodiments, the scaling factor may be configured by radio resource control (RRC) or medium access control control element (MAC-CE). In some embodiments, the scaling factor may be ½, 1 or 2. In some embodiments, the timing advance value may be configured for uplink transmission timing adjustment. In some embodiments, the report may include at least one of: an average delay, a delay spread, a Doppler shift, or a Doppler spread, that is determined according to a DL RS that refers to at least one DL RS of the plurality of DL RSs or is reported in the report. In some embodiments, the report may include at least one RS index that comprises at least one of: a RS resource index, a RS resource set index, a RS resource setting index, or a reporting configuration index, and the at least one RS index is associated with the timestamp, the time-difference information, the average delay, the delay spread, the Doppler shift, or the Doppler spread. In some embodiments, when the time-difference information comprises a time difference between receive timing and transmit timing, time difference between receive timing and reference timing, or time difference between transmit timing and reference timing, the time-difference information may be associated with one of the at least one RS index. In some embodiments, when the time-difference information comprises a reference signal time difference, the time-difference information may be associated with more than one RS indexes of the at least one RS index.

In some embodiments, more than one DL RS corresponding to the more than one RS indexes can be received simultaneously or associated with same group information. In some embodiments, more than one DL RS corresponding to the more than one RS indexes can be associated with different group information. In some embodiments, the report may include group information that is associated with at least one of: a timestamp, a time-difference information, an average delay, a delay spread, a Doppler shift, or a Doppler spread. In some embodiments, the report may include a channel quality parameter that comprises a reference signal received power (RSRP), a signal-to-interference-plus-noise ratio (SINR), a channel quality indicator (CQI), a precoding matrix indicator (PMI), a layer indicator (LI), or a rank indicator (RI). In some embodiments, the report may comprise uplink control information (UCI), channel state information (CSI) or a medium access control control element (MAC-CE). In some embodiments, the report may comprise CSI part 1. In some embodiments, the MAC-CE may be prioritized over at least one of following channels: Configured Grant Confirmation MAC CE or beam failure recovery (BFR) MAC CE or Multiple Entry Configured Grant Confirmation MAC CE, Sidelink Configured Grant Confirmation MAC CE, Listen before talk (LBT) failure MAC CE, MAC CE for side-link buffer status report (SL-BSR) prioritized, MAC CE for BSR, with exception of BSR included for padding, Single Entry power headroom (PHR) MAC CE or Multiple Entry PHR MAC CE, MAC CE for the number of Desired Guard Symbols, MAC CE for Pre-emptive BSR, MAC CE for SL-BSR, data from any Logical Channel, except data from uplink common control channel (UL-CCCH), MAC CE for Recommended bit rate query, MAC CE for BSR included for padding, or MAC CE for SL-BSR included for padding. In some embodiments, the MAC-CE may be de-prioritized over at least one of following channels: cell radio network temporary identifier (C-RNTI) MAC CE or data from UL-CCCH, Configured Grant Confirmation MAC CE or BFR MAC CE or Multiple Entry, Configured Grant Confirmation MAC CE, Sidelink Configured Grant Confirmation MAC CE, LBT failure MAC CE, MAC CE for SL-BSR prioritized, MAC CE for BSR, with exception of BSR included for padding, Single Entry PHR MAC CE or Multiple Entry PHR MAC CE, MAC CE for the number of Desired Guard Symbols, MAC CE for Pre-emptive BSR, MAC CE for SL-BSR, data from any Logical Channel, except data from UL-CCCH, MAC CE for Recommended bit rate query, or MAC CE for BSR included for padding.

In some embodiments, the wireless communication device may send the report to the wireless communication node, responsive to a triggering condition. In some embodiments, the triggering condition may comprise expiration of a timer, and an initial value for the timer is a specific value, configured by radio resource control (RRC) or medium access control control element (MAC-CE) signaling. In some embodiments, the triggering condition may comprise: when a channel quality parameter corresponding to a first DL RS is more than or equal to a threshold, or a difference in values of a channel quality parameter between a first DL RS and a second DL RS is more than or equal to the threshold, or when a channel quality parameter corresponding to a first DL RS is less than or equal to a threshold, or a difference in values of a channel quality parameter between a first DL RS and a second DL RS is less than or equal to a threshold. In some embodiments, the first DL RS may be included in the report, and the second DL RS may be included in the report or a previous report. In some embodiments, the threshold may be determined according to a value configured by RRC or MAC CE signaling and/or a channel quality parameter in the report or a previous report. In some embodiments, the channel quality parameter may comprise at least one of a reference signal received power (RSRP), a signal-to-interference-plus-noise ratio (SINR), a channel quality indicator (CQI), block error rate (BLER), or bit error rate (BER). In some embodiments, the triggering condition may be determined according to a channel quality parameter or a measurement result within a period. In some embodiments, a starting point of the period, or a length of period may be determined according to a value configured by RRC or MAC CE signaling. In some embodiments, the period may be determined to be a maximum or minimum between a period of a DL RS of the plurality of DL RSs and a defined number of time units. In some embodiments, the period may be determined to be a shortest or longest period among DL RSs of the plurality of DL RSs.

In some embodiments, the report may include N DL RSs, where N is a positive integer. In some embodiments, a DL RS with a best metric at a given timestamp may be reported in the report, and one of N DL RSs can be associated with a timestamp. In some embodiments, the N DL RSs may be selected from the plurality of DL RSs, and the configuration can be configured by radio resource control (RRC) or medium access control control element (MAC-CE) signaling. In some embodiments, a second RS in the report may be selected from the plurality of DL RSs according to a first RS that is included in a previous report, or is included in the report. In some embodiments, when the first DL RS is included in the report, the first DL RS may be associated with an earlier timestamp or associated with a smaller index corresponding to the timestamp. In some embodiments, an initial DL RS to be measured may be determined according to a DL RS for determining a quasi co-location (QCL) assumption of a downlink data channel or a downlink control channel. In some embodiments, the initial DL RS may be configured by RRC or MAC-CE signaling, or a DL RS with lowest or highest index (ID) in the pool. In some embodiments, an association between the DL RS or its time unit, and the UL RS or its time unit, may be indicated by downlink control information (DCI), radio resource control (RRC) or medium access control control element (MAC-CE) signaling. In some embodiments, a beam state may apply to both the DL RS and the UL RS. In some embodiments, the UL RS may be associated with a same spatial relation or a same beam as the DL RS. In some embodiments, one DCI may be to trigger transmission of both the DL RS and the UL RS. In some embodiments, spatial relation or beam of the UL RS may be determined based on the DL RS. In some embodiments, the configuration may be associated with a first reporting quantity. In some embodiments, a CSI request codepoint in the DCI may be associated with a resource set of the DL RS and a resource set of the UL RS, associated with both a CSI triggering state and an UL RS triggering state, or associated with both CSI triggering state and the resource set of the UL RS. In some embodiments, the CSI triggering state indicated by the DCI may be associated with a resource set comprising the UL RS. In some embodiments, at least one DL RS resources in the resource set of the DL RS may be quasi co-located (QCLed) or associated with a same transmission configuration indicator (TCI) state or same quasi co-location (QCL) Type RS. In some embodiments, at least one UL RS resources in the resource set of the UL RS can be QCLed or associated with a same TCI state or same spatial relation. In some embodiments, the DL RS may comprise a DL RS resource set. In some embodiments, the UL RS may comprise one or more UL resource sets, and at least one DL RS resource in the DL RS resource set can be divided into S DL RS resource subsets.

In some embodiments, the beam state may be indicated by the DCI, the MAC-CE or the RRC. In some embodiments, the DCI may comprise DCI format 0_0, DCI format 0_1 or DCI format 0_2. In some embodiments, the time-difference information may be included in the report carried in an UL channel initialized by the DCI. In some embodiments, the DL RS may comprise a channel state information RS (CSI-RS), wherein the CSI-RS is associated with a repetition parameter or a trs-info parameter. In some embodiments, the UL RS may comprise a sounding RS (SRS). In some embodiments, DL RS resource(s) in the DL RS resource subset may be QCLed or associated with a same TCI state or same QCL-Type RS. In some embodiments, one of at least one UL RS resource set may be mapped with a DL RS resource subset by DCI, MAC-CE or RRC signaling. In some embodiments, a spatial relation or pathloss RS corresponding to the one of the at least one UL RS resource set may be determined according to an associated DL RS, an associated DL RS sub-group, or a DL RS or DL RS sub-group in the report. In some embodiments, the UL RS may not be configured with at least one of: a spatial relation or a path loss RS. In some embodiments, an association between a first DL RS or its time unit, and a second DL RS or its time unit, may be indicated by downlink control information (DCI), radio resource control (RRC) or medium access control control element (MAC-CE) signaling.

In some embodiments, a channel state information (CSI) request codepoint in the DCI may be associated with two or more DL RS resource groups. In some embodiments, the first DL RS may be selected from a first DL RS group, and the second DL RS can be selected from a second DL RS group. In some embodiments, one DCI can trigger both the first DL RS and the second DL RS. In some embodiments, the configuration may be associated with a second reporting quantity. In some embodiments, DL RS resources in the first or second DL RS group can be quasi co-located (QCLed) or associated with a same beam or same quasi co-location (QCL) Type RS. In some embodiments, the DCI may comprise DCI format 0_0, DCI format 0_1 or DCI format 0_2. In some embodiments, the time-difference information may be included in the report carried in an UL channel initialized by the DCI, the MAC-CE or the RRC. In some embodiments, the DL RS may comprise a channel state information RS (CSI-RS), wherein the CSI-RS can be associated with a repetition parameter or a trs-info parameter.

At least one aspect is directed to a system, method, apparatus, or a computer-readable medium. A wireless communication node may send a configuration for a plurality of downlink (DL) reference signals (RSs) to a wireless communication device. The wireless communication device may receive at least one of the plurality of DL RSs. The wireless communication node may receive a report from the wireless communication device.

The systems and methods presented herein include a novel reporting approach for a wireless communication device, to enable artificial intelligence (AI) driven beam management. To predict a subsequent beam transition (e.g., by a wireless communication node) in a given period (e.g., 1 or more seconds), current reporting mechanisms used by the wireless communication device can be enhanced/improved by using additional assistance information (e.g., a timestamp for beam switching in a candidate beam pool, a physical propagation latency (such as RRT and/or TDOA), Doppler shift, and/or UE Rx beam/panel). The additional assistance information may be reported with other parameters, such as legacy beam/CSI related parameters (e.g., Tx beam/DL RS ID and/or RSRP/SINR). Event-driven procedures and/or reporting priority techniques may be considered for the reporting format (e.g., DCI and/or MAC-CE). The considered reporting formats may save/reduce reporting overhead, and can be suitable for training an AI and/or artificial neural network (ANN) model.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates example scenarios with a high-speed vehicle and one or more remote radio heads (RRHs), in accordance with some embodiments of the present disclosure;

FIG. 4 illustrates example measurements of beam dwelling time for a given wireless communication node antenna configuration, in accordance with some embodiments of the present disclosure;

FIGS. 5-6 illustrate example approaches for predictable beam management, in accordance with some embodiments of the present disclosure;

FIG. 7 illustrates example approaches for event-driven wireless communication device reporting for beam switching, in accordance with some embodiments of the present disclosure;

FIG. 8 illustrates example approaches for group information specific reporting, in accordance with some embodiments of the present disclosure;

FIGS. 9A-9B illustrate example approaches for round trip time (RTT) related reporting, in accordance with some embodiments of the present disclosure;

FIGS. 10-11 illustrate example approaches for reporting time difference information, in accordance with some embodiments of the present disclosure;

FIG. 12 illustrates example approaches for reporting the time difference information, in accordance with some embodiments of the present disclosure; and

FIG. 13 illustrates a flow diagram of an example method for reporting and beam management using artificial intelligence, in accordance with an embodiment of the present disclosure.

### DETAILED DESCRIPTION

### 1. Mobile Communication Technology and Environment

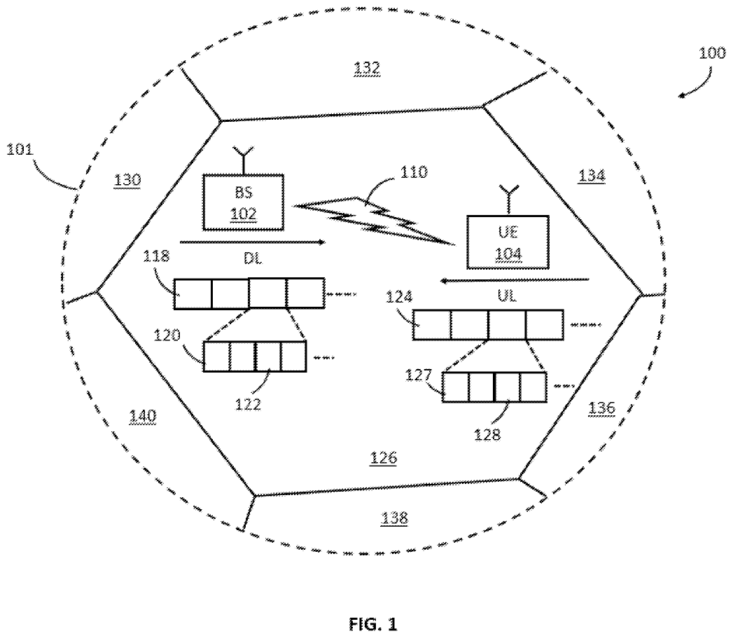

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

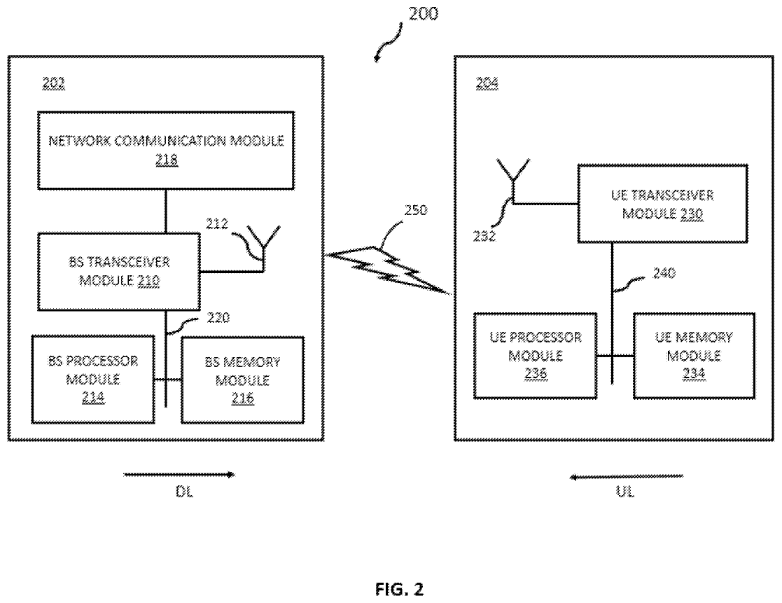

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Reporting and Beam Management Using AI

In certain systems (e.g., 5G new radio (NR) and/or other systems), mobile communication methods/procedures may use/implement/enable analog beam-forming techniques. Analog beam-forming may facilitate/increase/enhance the robustness of high-frequency communications and/or processes. In some embodiments, a quasi co-location (QCL) state and/or transmission configuration indicator (TCI) state (or beam state) may support/enable/facilitate beam indication for one or more types of channels and/or signals. For example, a QCL state and/or TCI state may support beam indication for downlink (DL) control channels (e.g., physical downlink control channel (PDCCH) and/or other channels), DL data channels (e.g., physical downlink shared channel (PDSCH) and/or other channels), and/or reference signals (e.g., channel state information reference signaling (CSI-RS) and/or other types of signals). In some embodiments, spatial relation information (e.g., higher layer parameters, such as spatialRelationInfo, and/or other parameters) and/or unified TCI state indication may support/enable/facilitate beam indication for one or more types of channels and/or signals. For instance, spatial relation information (and/or other information) may support beam indication for uplink (UL) control channels (e.g., physical uplink control channel (PUCCH)), reference signals (e.g., sounding reference signal (SRS)), and/or other types of channels/signals. For UL data channels (e.g., physical uplink shared channel (PUSCH) and/or other channels), beam indication can be achieved/implemented/enabled by mapping one or more SRS resources and/or one or more ports of an UL data channel. A wireless communication node (e.g., a ground terminal, a base station, a gNB, an eNB, or a serving node) may indicate/specify the one or more SRS resources. Therefore, a configuration of the beam for an UL data channel (or other channels) may be derived/determined/obtained by using the spatial relation information. The spatial relation information can be associated/related/linked with one or more SRS resources and/or ports of the UL data channel.

Current solutions, such as 5G NR solutions, may provide flexible configurations that are applicable to different/multiple scenarios. However, current solutions may be less effective in high mobility scenarios with a wireless communication device (e.g., a UE, a terminal, or a served node). For instance, in a high mobility scenario, a wireless communication device may travel/move at an increased speed (e.g., 300 Km/h or other speeds). Therefore, the corresponding beam dwelling time may be reduced/smaller (e.g., —10 ms or other time instances). A reduction in the corresponding beam dwelling time may cause an increase in reference signal (RS) overhead for beam tracking and/or a larger latency for beam indication in wireless communication device mobility.

In certain scenarios (e.g., high speed train (HST) scenario and/or other scenarios), the movement or trajectory of the wireless communication device may be stable/established/predictable. For instance, the wireless communication device may move/traverse along a high way and/or railway of a HST. In certain locations (e.g., in China), most rails are paved on viaducts and/or in rural areas, where the wireless channels are mostly line-of-sight (LOS). As a result, the predictable position information for a long period of a wireless communication device can be used as a key reference to determine/calculate/identify the coarse direction(s) of one or more beams for subsequent transmissions. Compared to approaches that use peripheral applications (e.g., global navigation satellite system (GNSS)) and/or other applications, wireless channel sensing techniques that use a predictive algorithm (e.g., an artificial intelligence (AI) algorithm) for positioning and/or beam switching (e.g., beam pattern matching methods, and/or position based methods) can be better suited for wireless communication devices. By using a predictive algorithm, the systems and methods presented herein (e.g., for next generation (NG) systems) may reduce/decrease costs and/or save inter-peripheral interface. The system and methods presented herein may consider/contemplate/address one or more of the following issues/challenges/problems:
1) The time point of a beam switch/transition (e.g., from a previous best beam to a new best beam in a candidate beam pool) can be important in beam pattern matching methods for predictable beam management. The time point of a beam switch/transition may be monitored/tracked by a wireless communication device. Therefore, event-driven reporting procedures for beam switching (e.g., a timestamp to be reported for indicating the time point(s) of beam switching) can be considered. In such a case, reporting overhead (e.g., caused by the reporting of the wireless communication device) can be significantly reduced.
2) With a predefined trajectory and/or physical map, a positioning of a wireless communication device can be performed based on (or by using) a single transmission and reception point (TRP) (e.g., a round-trip time (RTT)), at least two TRPs (e.g., a time difference of arrival (TDOA)), and/or downlink (DL) transmit (Tx) beam information. The physical propagation time (e.g., from the wireless communication node to the wireless communication device) of the reporting performed by the wireless communication device, and/or a time offset between receiving (e.g., by a wireless communication device) a DL signal and transmitting another uplink (UL) signal can be used to enable position-based methods for predictable beam management. Based on (or according to) a plurality of samples/measurements, the speed and/or accelerated speed of the wireless communication device can be estimated to emulate/approximate/reproduce the movement of the wireless communication device along a given map/trajectory.
3) One or more parameters for demodulation (e.g., Doppler shift, reference signal receive power (RSRP), and/or UE receive (Rx) beam/panel) in a receiver of the wireless communication device can be reported/communicated/provided (e.g., by the wireless communication device) as assistance/additional information. The assistance/additional information can be used to improve the estimation of the best/optimum beam(s) for subsequent transmissions.
4) Based on (or by using) the event-driven reporting procedure and/or the introduced parameter(s) for wireless communication device reporting (e.g. for AI driven beam management), a reporting format (e.g., medium access control control element (MAC-CE) signaling, and/or uplink control information (UCI)) and/or a transmission priority of the format can be considered.

In certain systems, the use of high frequency resources may induce/produce/cause a considerable propagation loss. Therefore, wide and/or ultra-wide spectrum resources may pose/introduce/cause noticeable challenges (e.g., due to propagation loss). In some embodiments, certain technologies/techniques may achieve/cause beam alignment and/or obtain/cause sufficient antenna gain. For example, antenna arrays and/or beam-forming training techniques that use massive multiple-input multiple-output (MIMO) (e.g., up to 1024 antenna elements for one node) may achieve beam alignment and/or sufficient antenna gain. In some embodiments, analog phase shifters may be used to implement/enable mmWave beam-forming. Using analog phase shifters may result in a low cost of implementation with the benefits of using antenna arrays. If analog phase shifters are used (e.g., to implement mmWave beam-forming), the number of controllable phases may be finite/defined/restricted. In some embodiments, the use of analog phase shifters may place/cause one or more constant modulus constraints on the analog phase shifters. Given a set of one or more pre-specified beam patterns, the goal/target of variable-phase-shift-based beamforming (BF) training may correspond to identifying/determining the optimum beam pattern for subsequent data transmissions. The identified beam pattern may apply to one or more scenarios with one transmit receive point (TRP) and/or one panel (e.g., a UE with one panel).

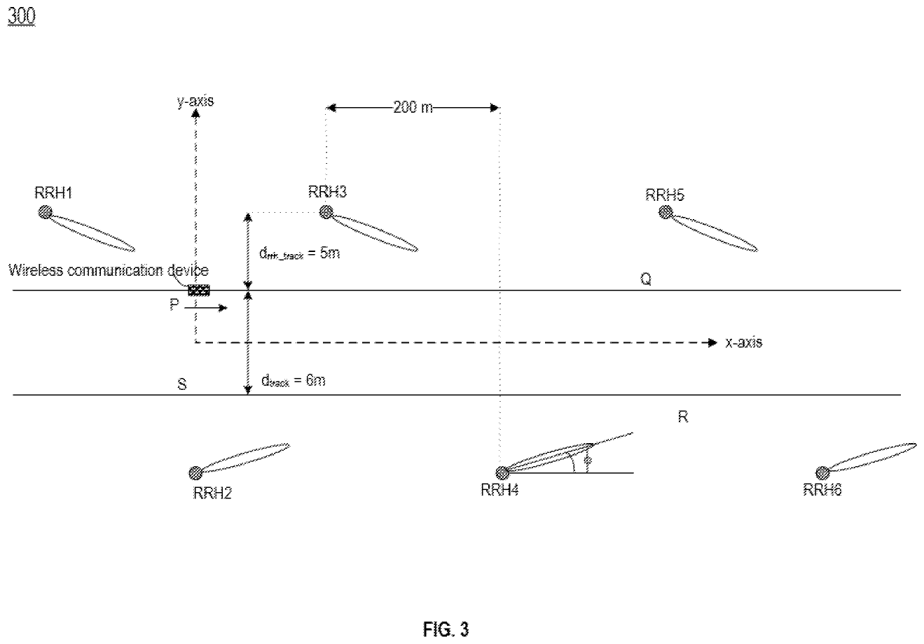

Referring now to FIG. 3, depicted is an example scenario 300 with a high-speed vehicle (e.g., a train) and one or more remote radio heads (RRHs), e.g., transmit receive points (TRPs). The example scenario may include six (or other numbers) RRHs (e.g., RRH1, RRH2, RRH3, RRH4, RRH5, RRH6, and/or other RRHs) and/or a wireless communication device with at least three (or other numbers) panels (e.g., a right panel, a top panel, and/or a left panel in a phone). The distance between two RRHs (e.g., RRH3 and RRH4) may be 200 meters (or other numbers), while the distance between the railway of the train (e.g., UE1) and at least one RRH (drrh_track) may be 5 meters (or other numbers). One or more RRHs may correspond to a same cell (e.g., save handover procedure), which produces/generates/emulates a long narrow cell along the railway. One or more TRPs may be deployed alongside a highway in an example scenario of a vehicle in the highway. In traditional beam management, beam tracking (or beam refinement) may be specific to a wireless communication device. Beam tracking (or beam refinement) can be wireless communication device specific because of the difficulty in guaranteeing that neighbouring/adjacent wireless communication devices (e.g., neighbouring in position) move together/jointly/correspondingly (e.g., with high probability). However, in a high mobility scenario (e.g., involving a highway and/or high-speed train), neighbouring/adjacent wireless communication devices may be in a same railway carriage, a same long-distance bus and/or a same group of cars.

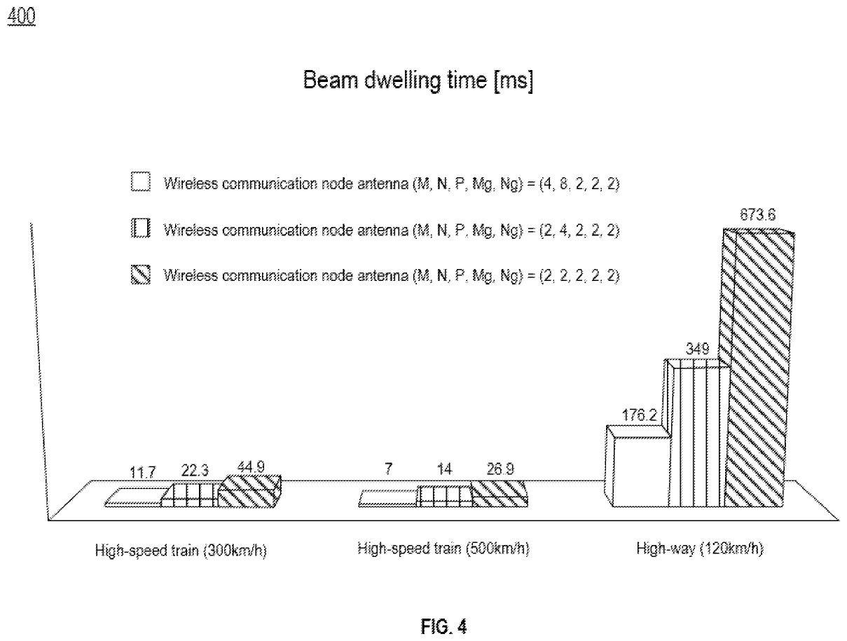

Referring now to FIG. 4, depicted are example measurements 400 of beam dwelling time for a given wireless communication node (e.g., gNB) antenna configuration. The beam dwelling time of the wireless communication node may include a beam dwelling time of a high-speed train (or other vehicles) traveling at 300 km/h, a high-speed train traveling at 500 km/h, and/or a vehicle in a highway traveling at a speed of 120 km/h. The beam dwelling time may be dependent/based/determined by one or more factors. The one or more factors may include the speed of the wireless communication device, the distance between the wireless communication node and the wireless communication device, the width of the beam(s), and/or other factors. In some embodiments, the beam dwelling time may be as small as 7 ms (or other numbers). Current beam management procedures/processes (e.g., beam reporting, beam group activation, and/or beam indication) may fail to update a beam within the smallest value of beam dwelling time (e.g., 7 ms and/or other time instances). In some embodiments, artificial intelligence (AI) techniques/approaches can be used to ensure one or more narrow beams provide better/increased/enhanced coverage and/or performance in high-speed scenarios. For instance, AI techniques can be employed/used/applied in beam prediction with trajectory prediction for mobility.

In some embodiments, a beam state may correspond/refer to a QCL state, a TCI state, a spatial relation state (or spatial relation information state), a reference signal (RS), a spatial filter, and/or pre-coding. In some embodiments of the present disclosure, a “beam state” may be referenced as a “beam”. Specifically:
a) A transmit (Tx) beam may correspond/refer to a QCL state, a TCI state, a spatial relation state, a DL/UL reference signal, a Tx spatial filter, and/or Tx precoding.
b) A receive (Rx) beam may correspond/refer to a QCL state, a TCI sate, a spatial relation state, a spatial filter, a Rx spatial filter, and/or Rx precoding.
c) A beam identifier (ID) may correspond/refer to a QCL state index, a TCI state index, a spatial relation state index, a reference signal index, a spatial filter index, a precoding index, and/or other indices.

In some embodiments, the spatial filter may correspond to the perspective of the wireless communication device and/or the wireless communication node. In some embodiments, the spatial filter may refer to a spatial-domain filter and/or other filters. In some embodiments, a spatial relation information may comprise one or more reference RSs. The spatial relation information may be used to specify/indicate/convey/represent the same or quasi-co spatial relation between a targeted RS/channel and the one or more reference RSs. In some embodiments, a spatial relation may refer to a beam, a spatial parameter, and/or a spatial domain filter.

In some embodiments, a QCL state may comprise one or more reference RSs and/or one or more corresponding QCL type parameters. The QCL type parameters may include at least one of a Doppler spread, a Doppler shift, a delay spread, an average delay, an average gain, and/or a spatial parameter (e.g., a spatial Rx parameter). In some embodiments, a TCI state may correspond/refer to a QCL state. In some embodiments, a QCL Type A may include a Doppler shift, a Doppler spread, an average delay, and/or a delay spread. In some embodiments, a QCL Type B may include a Doppler shift and/or Doppler spread. In some embodiments, a QCL Type C may include a Doppler shift and/or an average delay. In some embodiments, a QCL Type D may include a spatial Rx parameter. In some embodiments, a RS may comprise a channel state information reference signal (CSI-RS), a synchronization signal block (SSB) (or SS/PBCH), a demodulation reference signal (DMRS), a sounding reference signal (SRS), a physical random access channel (PRACH), and/or other signals/channels. In some embodiments, the RS may comprise at least one of a DL reference signal (DL RS) and/or UL reference signal (UL RS). In some embodiments, a DL RS may comprise at least one of a CSI-RS, SSB, and/or DMRS (e.g., DL DMRS). In some embodiments, an UL RS may comprise at least one of a SRS, DMRS (e.g., UL DMRS), and/or PRACH.

In some embodiments, an UL signal may include/comprise a PUCCH, a PUSCH, a SRS, and/or other channels/signals. In some embodiments, a DL signal may include/comprise a PDCCH, a PDSCH, a CSI-RS, and/or other channels/signals. In some embodiments, group based reporting may comprise at least one of beam group based reporting and/or antenna group based reporting.

In some embodiments, a beam group may refer to one or more distinct Tx beams of one group that are simultaneously received and/or transmitted. In some embodiments, a beam group may refer to one or more Tx beams of one or more different groups that may not be received and/or transmitted simultaneously. Furthermore, the definition of a beam group may correspond to the perspective of the wireless communication device. In some embodiments, an antenna group may refer to one or more distinct Tx beams of one group that may not be received and/or transmitted simultaneously. In some embodiments, an antenna group may refer to one or more Tx beams of one or more distinct groups that are simultaneously received and/or transmitted.
a) Furthermore, an antenna group may refer to more than N different/distinct Tx beams of one group that may not be received and/or transmitted simultaneously. An antenna group may refer to up to N different Tx beams of one group that are simultaneously received and/or transmitted. In some embodiments, N may be a positive integer.
b) Furthermore, an antenna group may refer to one or more Tx beams of one or more different groups that are simultaneously received and/or transmitted.

In some embodiments, the definition of an antenna group may correspond to the perspective of the wireless communication device. In some embodiments, an antenna group may correspond to an antenna port group, panel, and/or wireless communication device (e.g., UE) panel. In some embodiments, antenna group switching may correspond/refer to panel switching.

In some embodiments, group information may correspond to information grouping of one or more reference signals. In some embodiments, group information may include a resource set, a panel, a sub-array, an antenna group, an antenna port group, a group of antenna ports, a beam group, a transmission entity/unit and/or a reception entity/unit. In some embodiments, group information may represent/specify/indicate a wireless communication device (e.g., UE) panel and/or one or more features of the wireless communication device panel. In some embodiments, group information may refer to a group state and/or group ID.

In some embodiments, a time unit may include a sub-symbol, a symbol, a slot, a sub frame, a frame, a transmission occasion, and/or other time instances. In some embodiments, an active antenna group may correspond to an active DL antenna group, an active UL antenna group, an active DL and UL antenna group, and/or other groups.

### I. Embodiment 1: General Description of Wireless Communication Device Reporting to Enable Predictable Beam Management

In a high-speed railway (HSR) scenario, the trajectories of one or more trains may show periodicity and/or regularity. For position information, historical beam training results can become valuable references in future beam training processes. However, the accuracy of the position and/or environmental information may include one or more limitations. As a result, approaches/techniques for radiating/shaping/directing beams may be unable to completely depend on (or use) the measurements of position information. Therefore, appropriate beam measurement and/or reporting may be required to assist a predictable model (e.g., to achieve fine synchronization of beam transitions).

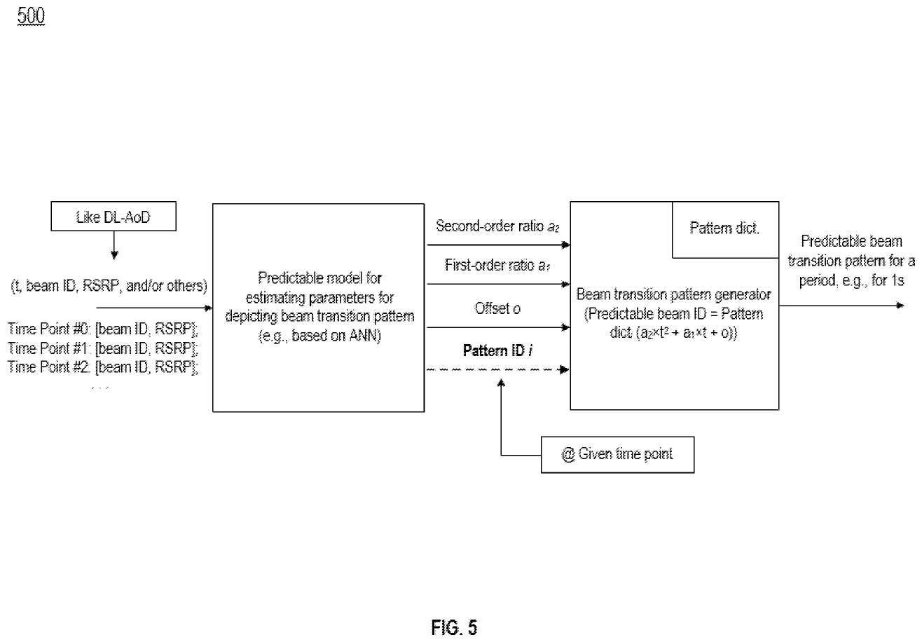

Referring now to FIG. 5, depicted is an example approach 500 for predictable beam management (e.g., a model-driven approach). Predictable beam management may comprise at least two parts: a predictable model for beam management and/or a beam transition pattern generator. The predictable model can be based on an artificial neutral network (ANN), a beam-level pattern matching algorithm, and/or other techniques/approaches. The predictable model can be used to estimate/configure one or more key parameters to determine one or more beam transitions (e.g., one or more beam transition patterns for a given period, such as 1 second). For instance, the one or more key parameters may include a first (a₁) and/or second (a₂) ratio of the current speed of the wireless communication device to the speed of the wireless communication device for generating a statistical pattern. The one or more key parameters may include a corresponding offset (o) and/or a type of pattern to be used (e.g., a Pattern ID (i), such as two or more parallel rails and/or a related UE movement direction).

The Pattern ID (i), second-order ratio (a₂), first-order ratio (a₁), and/or offset (o), as shown in FIG. 5, may include or correspond to unknown variables. From a Physics point of view, the variables of a₁ and/or a₂ may indicate/specify the first and/or second order ratio of the current speed of the wireless communication device to the speed of the wireless communication device for generating a statistical pattern. The variable o may indicate/specify the offset. For instance, if the speed of the wireless communication device for generating a statistical pattern in a dictionary is 300 km/h, the valuable value of a may include or correspond to [0.8˜1.2]˜240 km/h to 360 km/h. From the perspective of predictable performance, the approach 500 in FIG. 5 is mainly based on the probing points and/or identifying the exact timestamp for each beam transition. Each beam transition may include or correspond to a beam transition from a previous (e.g., old) best/optimum Tx beam to an updated (e.g., new) best Tx beam.

Identifying/determining the exact timestamp for each beam transition can be important for depicting/reproducing the beam switching pattern.

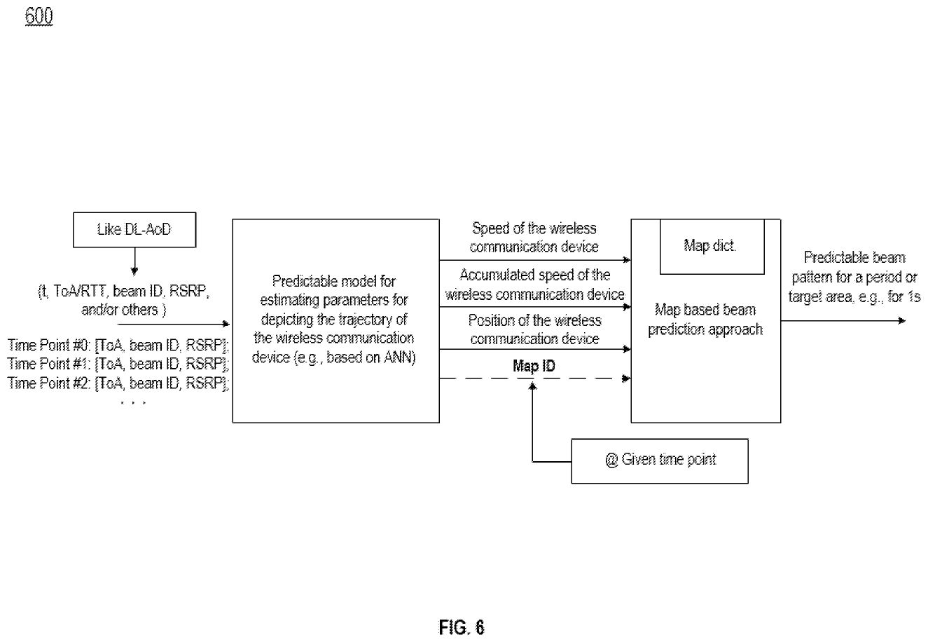

Referring now to FIG. 6, depicted is an example approach 600 for predictable beam management (e.g., a wireless communication device position-based approach). The approach 600 may comprise at least two parts. A first part may include or correspond to a predictable model for estimating the trajectory of the wireless communication device (e.g., enabled by an ANN algorithm). A second part may include or correspond to a map-based beam prediction approach. The first part can be used to estimate the parameters for determining the position of the wireless communication device (e.g., a location of the wireless communication device). The parameters may include a speed of the wireless communication device, an accumulated speed of the wireless communication device, and/or a map ID. The map ID may specify/indicate/provide a type of pattern to be used (e.g., two or more parallel rails and/or related movement direction of the wireless communication device). A time of arrival (ToA), a beam ID (e.g., a DL-AoD), a RSRP, and/or other parameters/inputs can be used to train/tune the AI model (e.g., ANN algorithm) for estimating the trajectory/positioning of the wireless communication device.

The following aspects may be considered for wireless communication device measurement and/or reporting for AI driven beam management. The wireless communication node may send/transmit/communicate a configuration for a plurality of DL reference signals (RSs).

After receiving/obtaining a plurality of DL RSs, a wireless communication device may report/provide/specify/indicate/inform (e.g., according to the RSs and/or the configuration) at least one of the following parameters in a report instance (e.g., report's time instance). A report instance may include or correspond to a single transmission of a report.
The report may include a timestamp (e.g., a time point/instance).
   The timestamp may include or correspond to a time unit, a symbol index (e.g., a orthogonal frequency-division multiplexing (OFDM) symbol), a slot index, a subframe index, a frame-index, a transmission occasion index (e.g., an UL signal and/or a DL signal), and/or the number of time units/symbols/slots/subframes/frames/transmission occasions before the report's time instance (e.g., an indication of a time duration relative to the time instance associated with the report).
   For instance, a timestamp may comprise: (a slot index)+(a subframe index)+(a frame index), such as a N-th slot in a M-th subframe index in the K-th frame index. In some embodiments, N, M, and K can be integers.
The report may include time-difference information. The time-difference information may comprise at least one of the following:
   A time difference between receive timing and transmit timing (e.g., a UE Rx−Tx time difference), and/or a time difference between transmit timing and receive timing.
      The time difference between receive timing and transmit timing can be defined from the perspective of wireless communication device.
      The time difference between receive timing and transmit timing (e.g., UE Rx−Tx time difference) may be defined as T_{UE-RX}−T_{UE-TX}, and/or T_{UE-TX}−T_{UE-RX}, where:
         T_{UE-RX} may include or correspond to the wireless communication device receive timing of a downlink time unit (e.g., subframe #i). Furthermore, T_{UE-RX} can be defined by the first detected path in time and/or a path with a strongest receive power in time.
         T_{UE-TX} may include or correspond to the wireless communication device transmit timing of an uplink time unit (e.g., subframe #i). Furthermore, the uplink time unit may be closest in time to the downlink time unit.
      The time difference between receive timing and transmit timing can be an important parameter for estimating (e.g., by the wireless communication node) a propagation time of the physical channel from the wireless communication node to the wireless communication device.
         For instance, the propagation time of the physical channel (e.g., time of arrival) may be determined according to (or based on) ((T_{TRP-RX}−T_{TRP-TX}) (T_{UE-RX}−T_{UE-TX}))/2. In some embodiments, T_{TRP-RX}−T_{TRP-TX} may denote/specify/indicate a time difference between transmit timing and receive timing of the wireless communication node (e.g., TRP). The wireless communication node may determine/identify the time difference between transmit timing and receive timing of the wireless communication node.
   A reference signal time difference (RSTD) (also known as time difference of arrival (TDOA))
      Furthermore, the RSTD may be defined from the perspective of the wireless communication device.
      Furthermore, the RSTD may indicate/specify the relative timing difference between the DL RS/TRP j and the reference DL RS/TRP defined as T_{Rxj}−T_{Rxi}, where:
         T_{Rxj} may include or correspond to the time when the wireless communication receives/obtains a first DL RS (e.g., DL RS/TRP j) and/or the start of one time unit corresponding to the first DL RS.
         T_{Rxi} may include or correspond to the time when the wireless communication device receives/obtains a second DL RS (e.g., DL RS/TRP i) and/or the start of one time unit corresponding to the second DL RS. Furthermore the time unit is closest/nearest in time to the time unit received from the first DL RS.
   A time difference between a receive timing and a reference timing, and/or a time difference between a transmit timing and a reference timing.
      Furthermore, the transmit timing may correspond to the time unit of transmitting an UL signal.
      Furthermore, the receive timing may correspond to the time unit of receiving a DL signal.
      Furthermore, the reference timing may correspond to a reference time unit.
   In order to save/reduce/decrease reporting overhead (e.g., number of bits) time-difference information may be determined according to (or based on) a mod function, a scaling factor, a reference time unit, a timing advance value, the time difference between receive timing and transmit timing, the time difference between transmit timing and receive timing, and/or a reference signal time difference.
      For instance, the time-difference information may be determined according to (the reference time unit (e.g., 1 subframe))−(a timing advance value)+(the time difference between receive timing and transmit timing).
      In some embodiments, the time-difference information may be determined according to ((−a timing advance value)+(the time difference between receive timing and transmit timing)) mod (the reference time unit)
      In some embodiments, the time-difference information may be determined according to (a reference time unit (e.g., 1 subframe))−(a timing advance value)*(a scaling factor)+(the time difference between receive timing and transmit timing). The scaling factor may have a value of ½ (or other values).
      In some embodiments, the time-difference information may be determined according to (the time difference between receive timing and transmit timing) mod (the reference time unit).
      In some embodiments, the timing advance value may be configured according to higher layer signaling, such as radio resource control (RRC) and/or medium access control control element (MAC-CE), for UL transmission timing adjustments.
The report may include an average delay and/or a delay spread.
   The average delay and/or delay spread can be estimated with a DL RS that is configured by the wireless communication node. The average delay and/or delay spread may be reported/communicated in the report instance.
   The average delay may refer to an average delay of a physical channel propagation. The delay spread may refer to the spread of the delay of a physical channel propagation.
The report may include a Doppler shift and/or Doppler spread.
   The Doppler shift and/or Doppler spread may be estimated with a DL RS that is configured by the wireless communication node. The Doppler shift and/or Doppler spread may be reported in the report instance.
The report may include/provide/indicate/specify at least one RS index.
   The at least one RS index may comprise at least one or a combination of: a RS resource index, a RS resource set index, a RS resource setting index, and/or a reporting configuration index.
   The timestamp and/or time-difference information may be associated/related with the at least one RS index.
      If the time-difference information comprises the time difference between receive timing and transmit timing, and/or the time difference between transmit timing and receive timing, the time-difference information may be associated with one of the at least one RS index.
      If the time-difference information comprises a reference signal time difference, the time-difference information may be associated/related with more than one RS index of the at least one RS index.
         In some embodiments, the more than one RS corresponding to the more than one RS index can be received simultaneously, and/or associated with a particular group information (e.g., a beam group).
The report may include group information.
   The group information may be associated/related with the time-difference information, an average delay, a delay spread, a Doppler spread, and/or a Doppler shift.
The report may include a channel quality parameter.
   The channel quality parameter may comprise a RSRP, a signal-to-interference-plus-noise ratio (SINR), a channel quality indicator (CQI), a precoding matrix indicator (PMI), a layer indicator (LI), and/or a rank indicator (RI).

In some embodiments, the timestamp may be associated with the time-difference information, the Doppler shift, a RS index, group information and/or the channel quality parameter.
Therefore, the time-difference information, the Doppler shift, the average delay, the RS index, the group information and/or the channel quality parameter to be reported may be determined according to (or based on) the timestamp and/or the time point corresponding to the timestamp.

In some embodiments, the report instance may comprise uplink control information (UCI), channel state information (CSI), and/or MAC-CE (e.g., MAC-CE information).
In some embodiments, the report instance may comprise CSI part 1.
Furthermore, the MAC-CE can be prioritized over at least one of the following channels:
   Configured Grant Confirmation MAC CE or BFR MAC CE or Multiple Entry Configured Grant Confirmation MAC CE;
   Sidelink Configured Grant Confirmation MAC CE;
   LBT failure MAC CE;
   MAC CE for SL-B SR prioritized;
   MAC CE for B SR, with exception of B SR included for padding;
   Single Entry PHR MAC CE or Multiple Entry PHR MAC CE;
   MAC CE for the number of Desired Guard Symbols;
   MAC CE for Pre-emptive BSR;
   MAC CE for SL-B SR;
   data from any Logical Channel, except data from UL-CCCH;
   MAC CE for Recommended bit rate query;
   MAC CE for B SR included for padding; or
   MAC CE for SL-B SR included for padding.
Furthermore, the MAC-CE may be de-prioritized over at least one of the following channels:
   C-RNTI MAC CE or data from UL-CCCH;
   Configured Grant Confirmation MAC CE or BFR MAC CE or Multiple Entry Configured Grant Confirmation MAC CE;
   Sidelink Configured Grant Confirmation MAC CE;
   LBT failure MAC CE;
   MAC CE for SL-B SR prioritized;
   MAC CE for B SR, with exception of B SR included for padding;
   Single Entry PHR MAC CE or Multiple Entry PHR MAC CE;
   MAC CE for the number of Desired Guard Symbols;
   MAC CE for Pre-emptive BSR;
   MAC CE for SL-B SR;
   data from any Logical Channel, except data from UL-CCCH;
   MAC CE for Recommended bit rate query; or
   MAC CE for B SR included for padding.

### II. Embodiment 2: Event-Driven Wireless Communication Device Reporting for Beam Switching

The wireless communication device can monitor/track/determine/identify the time point of a beam switch (e.g., which can be used for beam pattern matching in certain methods, such as AI-based methods, for predictable beam management). Therefore, event-driven reporting procedures regarding beam switching can be considered. In some embodiments, the wireless communication device can report/specify/provide the timestamp related to a beam transition, and/or an effective time of a RS to be reported.

If the triggering condition is satisfied, the wireless communication device may report/inform/provide the timestamp. The triggering condition may comprise at least one of the following.
The triggering condition may comprise an expiration of a timer.
   An initial value for the timer (e.g., initial value for resetting and/or setting the timer) can be configured according to (or by using) a RRC and/or MAC-CE command.
The triggering condition may comprise a channel quality parameter, corresponding to a first RS, being more than or equal to a threshold. In some embodiments, the triggering condition may comprise a difference of the channel quality parameter, corresponding to a first RS, over a second RS being more than or equal to a threshold.
   In some embodiments, the first RS (e.g., an index of the first RS) can be included/specified in the report instance. The second RS (e.g., an index of the second RS) may be reported/informed/indicated in a previous report instance.
   The threshold may be determined according to (or based on) a value configured by RRC signaling and/or MAC-CE signaling. In some embodiments, the threshold may be determined/configured according to a channel quality parameter of a previous report instance (e.g., a last report instance).
      For example, if the threshold is determined according to a channel quality parameter in a previous report instance, the threshold may correspond to the channel quality parameter plus an offset value. The offset value may be configured by using RRC signaling, MAC-CE, and/or other types of signaling.
   The metric corresponding to the threshold can be RSRP, SINR, and/or CQI.
The triggering condition may comprise a channel quality parameter, corresponding to a first RS, being less than or equal to a threshold. In some embodiments, the triggering condition may comprise the change of the channel quality parameter, corresponding to a first RS, over a second RS being less than or equal to a threshold.
   The first RS (e.g., an index of the first RS) can be included/provided/specified in the report instance. The second RS (e.g., an index of the second RS) may be reported/included in a previous report instance.
   The threshold may be determined according to (or based on) a value configured by RRC and/or MAC-CE signaling. The threshold may be determined/configured according to a channel quality parameter in a previous report instance (e.g., last report instance).
      For example, if the threshold is determined according to a channel quality parameter in a previous report instance, the threshold may correspond to the channel quality parameter plus an offset value. The offset value may be configured by using RRC signaling, MAC-CE, and/or other types of signaling.
   The metric corresponding to the threshold may be a block error rate (BLER) and/or a bit error rate (BER).
The channel quality parameter may be determined according to (or based on) measurement results within a period (e.g., a window).
   The starting point of the period and/or the length of the period may be determined according to (or based on) a value configured by RRC signaling, MAC-CE signaling, and/or other types of signaling.
   In some embodiments, the period may be determined to be the maximum or minimum between a period of a DL RS and/or a defined/configured number of time units (e.g., X time units, such as 2 ms).
   In some embodiments, the period may be determined to be a shortest or longest time period among a plurality of DL RSs to be measured.

In some embodiments, the report may include/specify/indicate N DL RS(s). N may be a positive integer.
The RS (among the N DL RS(s)) with the best metric at a given timestamp is reported in the report (e.g., report instance). At least one of the N DL RS(s) may be associated with a timestamp.
The N DL RS(s) can be selected/identified/configured from a plurality of DL RSs configured by RRC and/or MAC-CE signaling.
A second RS in the report instance may be selected/identified from the plurality of DL RSs according to (or based on) the first RS that has been reported in a previous report, and/or is included in the report.
   If the first DL RS is included in the report instance, the first DL RS may be associated with an earlier timestamp and/or associated with a smaller index corresponding to the timestamp.
   The plurality of DL RSs may be configured by RRC signaling (and/or other types of signaling). Neighboring DL RSs (e.g., included in the plurality of DL RSs) corresponding to the first DL RS may be selected for the subsequent measurement and/or reporting. Therefore, the second DL RS(s) may be selected from the neighboring DL RSs.
      The initial DL RS to be measured may be determined according to (or based on) the DL RS and/or SSB for determining a QCL assumption of a DL data channel and/or a DL control channel.
      The initial DL RS may be configured by RRC and/or MAC-CE signaling, or a DL RS with a lowest or highest ID in the plurality of DL RSs.

In some embodiments, a timestamp may be associated/related with the group information.

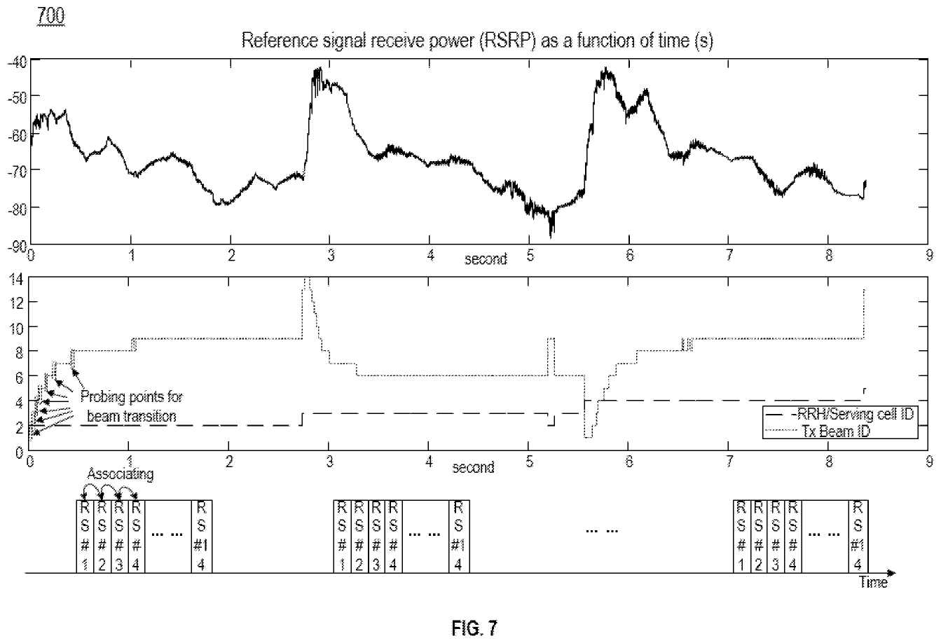

Referring now to FIG. 7, depicted is an example approach 700 for event-driven wireless communication device reporting for beam switching. In one example, M=14 RSs (e.g., CSI-RS and/or other RSs) may be configured by using RRC signaling (or other types of signaling) for beam management and/or tracking. The initial RS may be assumed to be the RS with the lowest/smallest index (e.g. RS #0). The RS #1 and/or the RS #2, associated with the RS #1, can be measured by the wireless communication device. When the channel quality (e.g., RSRP) of the RS #2 is more than the channel quality of the RS #1 plus an offset (e.g., 3 dB), the wireless communication device may report/provide/specify the index of the RS #1 and/or the corresponding timestamp. The RS #2 and/or {RS #1, RS #3} associated with the RS #1 can be subsequently measured.

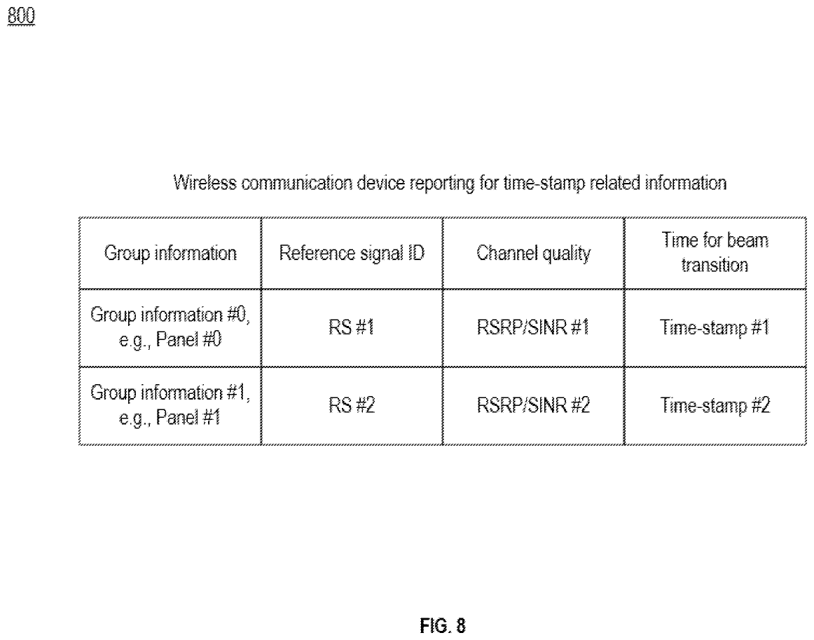

In certain embodiments with multi-UE panel, group information specific reporting can be considered/used. An example approach 800 for group information specific reporting is depicted in FIG. 8. If the RS #0 is an initial RS for beam measurement, the channel quality of the RS #1, with group information #0, can meet the condition of the channel quality parameter at the time instance related to timestamp #1. Furthermore, the channel quality of RS #2, with group information #1, can meet the condition of the channel quality parameter at the time instance related to timestamp #2. In this example, the condition may be that, based on the channel measurement corresponding to a particular group information (e.g., using UE panel #1), the difference between the channel quality parameter of the RS to be reported and the channel quality parameter of the initial RS is more than an offset value. The offset value (e.g., 3 dB) may be configured/determined by RRC signaling (and/or other types of signaling).

### III. Embodiment 3: Round-Trip Time Related Reporting to Assist in Wireless Communication Device Positioning

In a predefined trajectory, a parameter related to the round-trip time (RTT) (e.g., a time difference between a receive timing and a transmit timing (UE Rx-Tx time difference)) can be of high importance for guaranteeing/improving/enhancing the accuracy of the positioning. For instance, as discussed in Embodiment 1, an estimated ToA may correspond to ((UE Rx-Tx time difference)+(TRP Rx-Tx time difference))/2.

In some embodiments, an association/relationship between a DL RS/time unit i and an UL RS/time unit j can be initialized/indicated by DCI, MAC-CE signaling, and/or RRC signaling.
In some embodiments, the UL RS may be associated with the DL RS. The time-difference information may be determined according to (or based on) a DL RS and/or an UL RS.
   In some embodiments, a beam state may apply to both the DL RS and the UL RS.
   In some embodiments, the UL RS may be associated with a same spatial relation and/or a same beam as the DL RS.
A single DCI can trigger both the DL RS and the UL RS. The time-difference information may be carried/included in the reporting.
   The spatial relation and/or beam of the UL RS may be determined based on (or according to) the DL RS.
   The DCI may comprise DCI format 0_0, DCI format 0_1 and/or DCI format 0_2.
   In some embodiments, the DL RS may comprise a CSI-RS.
      Furthermore, the CSI-RS may be used for beam management and/or for tracking.
      Furthermore, the CSI-RS may be associated with a repetition parameter and/or a trs-info parameter (or other parameters).
   In some embodiments, the reporting configuration may be configured with the reporting quantity=none, time-difference, RTT, ssb-Index-RSRP, cri-RSRP, ssb-Index-SINR, and/or cri-SINR.
   In some embodiments, the CSI request codepoint in the DCI may be associated with both the DL RS resource set and the UL RS resource set. The CSI request codepoint in the DCI may be associated with both the CSI triggering state and the UL RS triggering state. In some embodiments, the CSI request codepoint in the DCI may be associated with both the CSI triggering state and the UL RS resource set.
      In some embodiments, the CSI triggering state in the DCI may be associated with the SRS resource set.
   The DL RS resource in the resource set may be quasi co-located (QCLed) and/or associated with the same TCI state and/or same QCL-Type RS.
   In some embodiments, the UL RS resource in the resource set can be QCLed and/or associated with the same/corresponding TCI state and/or same spatial relation.
   In some embodiments, the DL RS may comprise a DL RS resource set. The UL RS may comprise one or more UL resource sets. The DL RS resource(s) in the DL RS resource set can be divided into S DL RS resource subsets.
      The DL RS resource in the DL RS resource subset may be QCLed and/or associated with a same TCI state and/or the same QCL-Type RS.
      In some embodiments, at least one of the UL RS resource sets may be mapped/associated/related with the DL RS resource subset by DCI, MAC-CE signaling and/or RRC signaling. The spatial relation and/or pathloss RS corresponding to the at least one of UL RS resource set may be determined according to (or based on) an associated DL RS and/or an associated DL RS subgroup.
      In some embodiments, at least one DL RS in the subset and/or one subset may be reported/specified/indicated in the report instance (e.g., a report). The spatial relation and/or pathloss RS corresponding to the at least one of the UL RS resource sets can be determined according to the at least one DL RS in the subset and/or one subset.
      In such a case, the SRS resource may not be configured with a spatial relation and/or path loss RS.
In some embodiments, the time difference between a receive timing and a transmit timing may correspond to: (T_{UE-RX} of the corresponding DL RS)−(T_{UE-TX} of the corresponding UL RS). One example for UE Rx-Tx time difference can be the following:
   The UE Rx−Tx time difference can be defined as T_{UE-RX}−T_{UE-TX}, where:
      T_{UE-RX} may be the wireless communication device received timing of the downlink time unit (e.g., a subframe) #i from a wireless communication node (e.g., TRP), defined by the first detected path in time.
      T_{UE-TX} may be the wireless communication device transmit timing of the uplink time unit #j that is closest in time to the subframe #i received from the wireless communication node.
      A plurality of DL PRS resources can be used to determine the start of one time unit of the first arrival path of the wireless communication node.
   For frequency range 1, the reference point for a T_{UE-RX} measurement can be the Rx antenna connector of the wireless communication device. The reference point for a T_{UE-TX} measurement may be the Tx antenna connector of the wireless communication device. For frequency range 2, the reference point for the T_{UE-RX} measurement shall be the Rx antenna of the wireless communication device. The reference point for T_{UE-TX} measurement may be the Tx antenna of the wireless communication device.

For instance, one aperiodic CSI triggering state may be associated/related with a CSI-RS resource set and/or a SRS resource set. The CSI-RS may be used for tracking and/or beam management. The SRS resource set may be used for beam management.

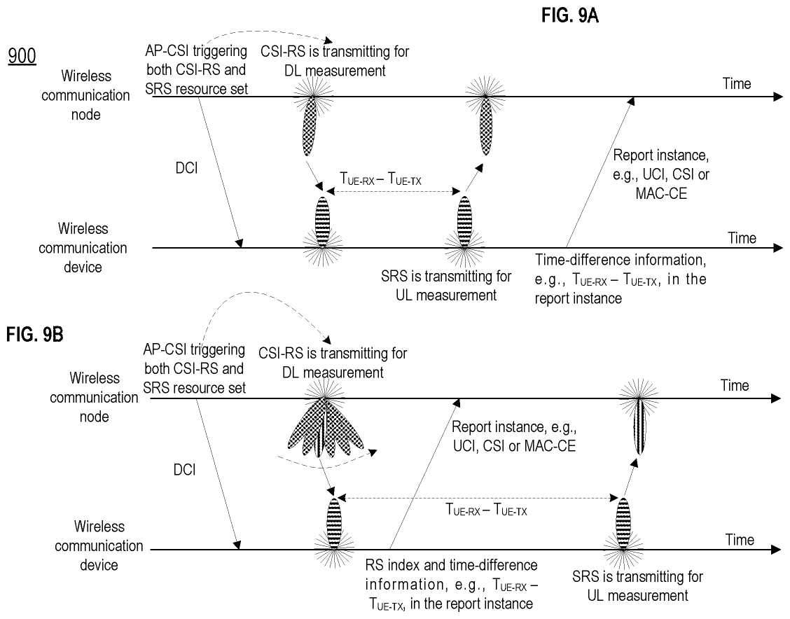

Referring now to FIG. 9A, a DCI command may initialize an aperiodic CSI-RS and/or an aperiodic SRS transmission. The CSI-RS and/or the SRS are configured TCI state and/or spatial relation (e.g., respectively). As a condition, the CSI-RS and/or the SRS may be associated with a same beam. The reporting quantity may be configured with none or time-difference. The CSI-RS may be transmitted, followed by a transmission of the SRS. The time difference information can be determined according to (or by using) the first CSI-RS resource and the first SRS resource to be transmitted and/or in the corresponding set. Therefore, the report instance carrying the time-difference information (e.g., UE Rx-Tx time difference) may correspond to T_{UE-RX}−T_{UE-TX}.

Referring now to FIG. 9B, a CSI-RS with preconfigured TCI state, and/or a spatial relation of the SRS may be determined according to (or based on) the CSI-RS to be reported in the report instance. Specifically, a CSI-RS resource set may be triggered by a DCI. At least one CSI-RS may be reported in the report instance. In some embodiments, the time difference information (e.g., UE Rx-Tx time difference), T_{UE-RX}−T_{UE-TX}, can be carried/included/provided in the report instance.

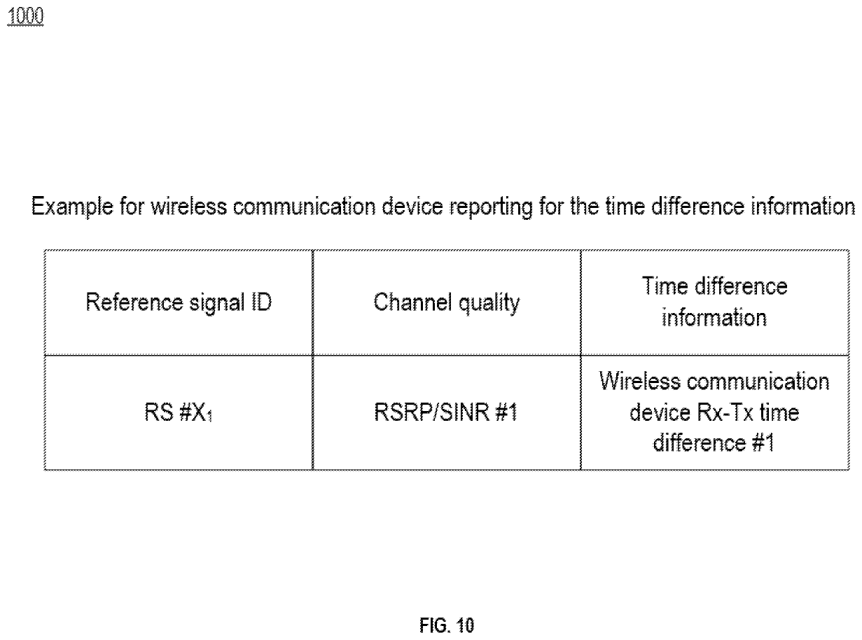

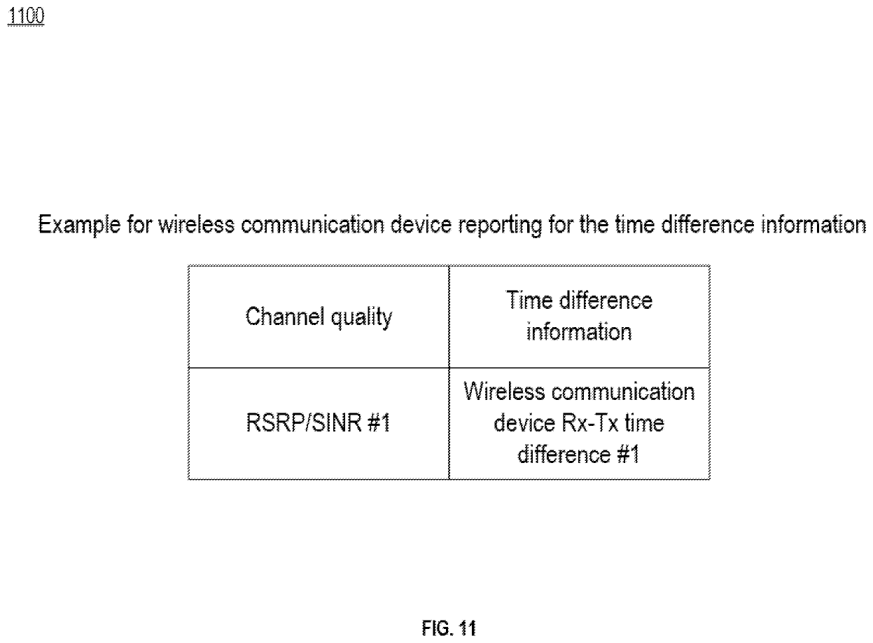

Referring now to FIGS. 10-11, depicted are example approaches for reporting/providing (e.g., by the wireless communication device) time difference information. As depicted in FIG. 10, there are a plurality of candidate QCL parameters for the DL RSs to be measured. The RS ID selected by the wireless communication device can be reported/provided via the report (e.g., FIG. 9B). The spatial relation and/or spatial filter of the SRS resource set may be determined according to (or based on) the RS ID. As depicted in FIG. 11, all DL RS can be QCLed. Therefore, the RS ID information may not be used, and hence, the RS ID field can be cancelled (e.g., FIG. 9A). In some embodiments, the report may include/provide/specify a channel quality, the time-difference information and/or a timestamp. In addition to the time difference information, the Doppler shift and/or average delay information can be included/specified/provided in the report.

### IV. Embodiment 4: Time Difference of Arrival Related Reporting to Assist in Wireless Communication Device Positioning

In a predefined trajectory, a parameter related to the TDOA (e.g., a RS time difference) can be of high importance for guaranteeing/improving/enhancing the accuracy of the positioning. Compared with the RTT method (e.g., Embodiment 3), the TDOA-related parameter may be determined according to (or by using) at least two DL RSs from different/separate/distinct wireless communication nodes and/or beams. For a DL RS pair (e.g., 2 DL RSs), a single reference signal time difference (RSTD) may be determined.

An association/relationship between a first DL RS and its time unit (e.g., time unit i), and/or a second DL RS and its time unit (e.g., time unit j) can be initialized/indicated by DCI, MAC-CE signaling, and/or RRC signaling.
In some embodiments, a reference signal time difference may be determined/calculated according to (or by using) at least two DL RSs. The at least two DL RSs can be received simultaneously. In some embodiments, the at least two DL RSs may be from different DL RS resource groups, and/or correspond to different group information.
   In some embodiments, the CSI request codepoint in the DCI may be associated/related with two or more DL RS resource groups (e.g., two DL RS resource groups and/or subsets).
In some embodiments, the first DL RS can be selected/determined/identified from a first DL RS group. The second DL RS may be selected from a second DL RS group.
   The DL RS resources in the DL RS group may be QCLed and/or associated with a same/corresponding TCI state and/or a same QCL-Type RS.
A single DCI may be used to trigger the first DL RS and/or the second DL RS. The time difference information may be carried/included/specified/provided in the reporting (e.g., in the report).
   The DCI may comprise a plurality of formats, such as a DCI format 0_0, a DCI format 0_1, and/or a DCI format 0_2.
   In some embodiments, the DL RSs may comprise a CSI-RS.
      The CSI-RS may be used for beam management and/or for tracking.
      Furthermore, the CSI-RS may be associated/related with a repetition parameter and/or a trs-info parameter.
   In some embodiments, the reporting configuration may be configured with the reporting quantity=none, time difference, TDOA, ssb-Index-RSRP, cri-RSRP, ssb-Index-SINR, and/or cri-SINR.
   The reference signal time difference may include or correspond to (TSL-Rx of a DL RS)−(TSL-Tx of another DL RS). For instance, one example for the UE Rx-Tx time difference can be the following:
      The reference signal time difference (RSTD) can be defined as the DL relative timing difference between the wireless communication node (e.g., TRP) j and the reference wireless communication node i (e.g., T_{DL-Rxj}−T_{DL-Rxi}, where:
         T_{SubframeRxj} may specify or correspond to the time when the wireless communication device receives the start of one time unit (e.g., a subframe) from the wireless communication node j.
         T_{SubframeRxi} may specify or correspond to the time when the wireless communication device receives the corresponding start of one time unit from wireless communication node i that is closest in time to the subframe received from wireless communication node j.
         A plurality of DL RS resources can be used to determine the start of one time unit from a wireless communication node.
      For frequency range 1, the reference point for the DL RSTD may be the antenna connector of the wireless communication device. For frequency range 2, the reference point for the DL RSTD may be the antenna of the wireless communication device.

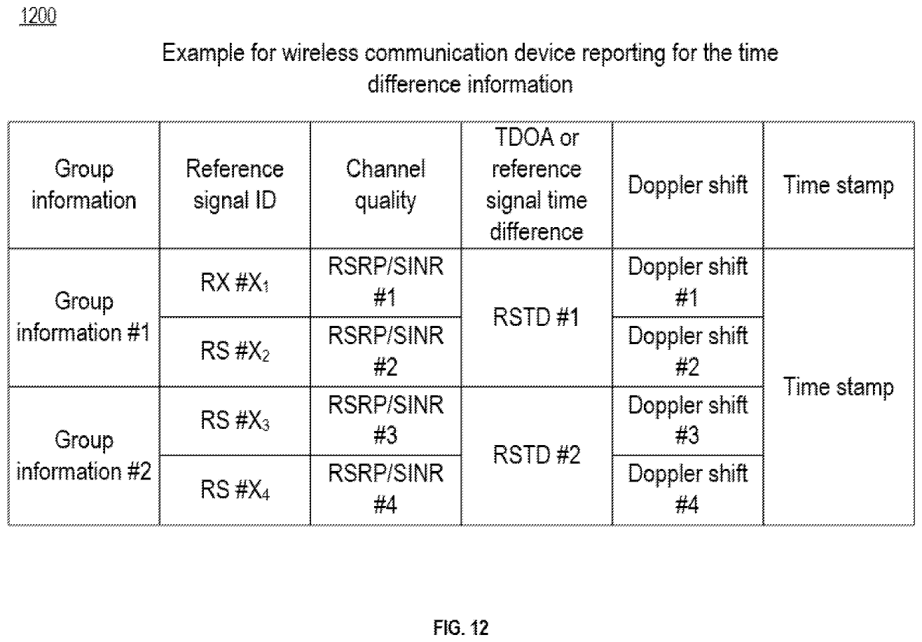

For instance, a DCI format 0_0/1/2 may initialize/indicate a CSI-RS with repetition=on/off and/or a reporting quantity=TDOA. The TDOA and/or corresponding timestamp may be reported/specified/indicated/provided in the report instance (e.g., in a report), as shown in FIG. 12. For example, for a particular group (e.g., group #1, and/or group #2), at least two RSs (e.g., RS #X₁, RS #X₂, and/or other RSs), a respective channel quality (e.g., RSRP/SINR #1, RSRP/SINR #2, and/or other RSRPs/SINRs), and/or a respective Doppler shift (e.g., Doppler shift #1, Doppler shift #2, and/or other Doppler shifts) are reported. A single RSTD can be reported for each group, where the RSTD may be determined according to (or based on) the two RSs. In addition, a timestamp may be reported/specified/provided/indicated.

### V. Reporting and Beam Management Using AI

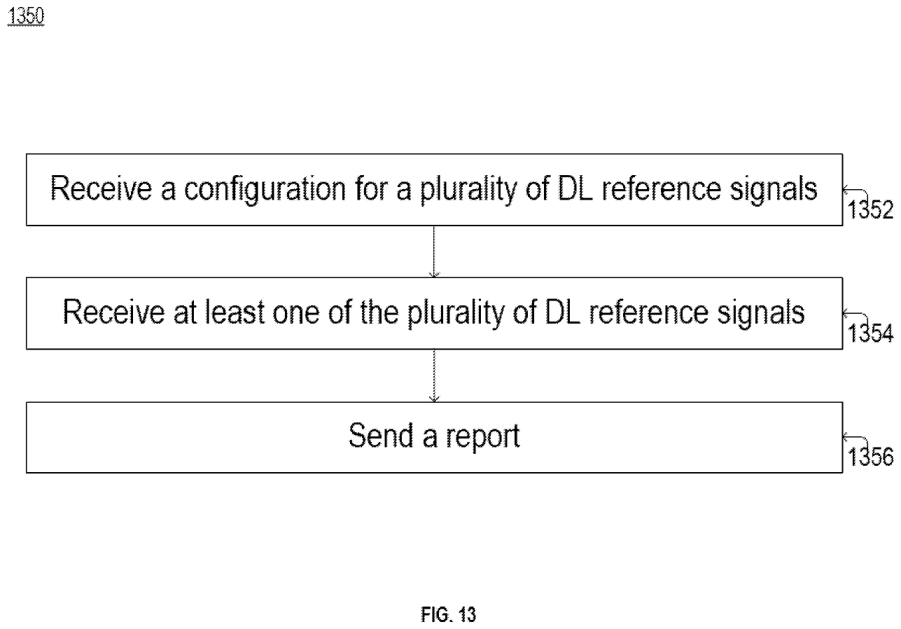

FIG. 13 illustrates a flow diagram of a method 1350 for reporting and beam management using AI. The method 1350 may be implemented using any of the components and devices detailed herein in conjunction with FIGS. 1-12. In overview, the method 1350 may include receiving a configuration for a plurality of DL reference signals (1352). The method 1350 may include receiving at least one of the plurality of DL reference signals (1354). The method 1350 may include sending a report (1356).

Referring now to operation (1352), and in some embodiments, a wireless communication device (e.g., a UE) may receive/obtain/acquire a configuration from a wireless communication node (e.g., gNB). The wireless communication node may send/transmit/broadcast/communicate the configuration to the wireless communication device. The configuration may include a configuration for a plurality of DL RSs In some embodiments, the wireless communication device may send/transmit a report (e.g., according to the configuration). In some embodiments, the report may include/provide/specify group information. The group information may be associated with at least one of: a timestamp, a time-difference information, an average delay, a delay spread, a Doppler shift, and/or a Doppler spread. In some embodiments, the report may include or provide a channel quality parameter and/or other information. The channel quality parameter may comprise or correspond to a reference signal received power (RSRP), a signal-to-interference-plus-noise ratio (SINR), a channel quality indicator (CQI), a precoding matrix indicator (PMI), a layer indicator (LI), and/or a rank indicator (RI). In some embodiments, the report may comprise uplink control information (UCI), channel state information (CSI) and/or a medium access control control element (MAC-CE). In some embodiments, the report may comprise CSI part 1. In some embodiments, the MAC-CE may be prioritized over at least one of following channels: Configured Grant Confirmation MAC CE or beam failure recovery (BFR) MAC CE or Multiple Entry Configured Grant Confirmation MAC CE, Sidelink Configured Grant Confirmation MAC CE, Listen before talk (LBT) failure MAC CE, MAC CE for side-link buffer status report (SL-BSR) prioritized, MAC CE for BSR, with exception of BSR included for padding, Single Entry power headroom (PHR) MAC CE or Multiple Entry PHR MAC CE, MAC CE for the number of Desired Guard Symbols, MAC CE for Pre-emptive BSR, MAC CE for SL-BSR, data from any Logical Channel, except data from uplink common control channel (UL-CCCH), MAC CE for Recommended bit rate query, MAC CE for BSR included for padding, or MAC CE for SL-BSR included for padding. In some embodiments, the MAC-CE may be de-prioritized over at least one of following channels: cell radio network temporary identifier (C-RNTI) MAC CE or data from UL-CCCH, Configured Grant Confirmation MAC CE or BFR MAC CE or Multiple Entry, Configured Grant Confirmation MAC CE, Sidelink Configured Grant Confirmation MAC CE, LBT failure MAC CE, MAC CE for SL-BSR prioritized, MAC CE for BSR, with exception of BSR included for padding, Single Entry PHR MAC CE or Multiple Entry PHR MAC CE, MAC CE for the number of Desired Guard Symbols, MAC CE for Pre-emptive BSR, MAC CE for SL-BSR, data from any Logical Channel, except data from UL-CCCH, MAC CE for Recommended bit rate query, or MAC CE for BSR included for padding.

In some embodiments, the wireless communication device may send/transmit/communicate the report to the wireless communication node, responsive to a triggering condition. In some embodiments, the triggering condition may comprise or correspond to an expiration of a timer. An initial value for the timer may be a specific value. The initial value may be configured by (or according to) radio resource control (RRC) signaling, medium access control control element (MAC-CE) signaling, and/or other types of signaling. In some embodiments, the triggering condition may comprise: when a channel quality parameter corresponding to a first DL RS is more than or equal to a threshold, or a difference in values of a channel quality parameter between a first DL RS and a second DL RS is more than or equal to the threshold, or when a channel quality parameter corresponding to a first DL RS is less than or equal to a threshold, or a difference in values of a channel quality parameter between a first DL RS and a second DL RS is less than or equal to a threshold. In some embodiments, the first DL RS may be included/provided/specified in the report. The second DL RS may be included/specified in the report and/or a previous report. In some embodiments, the threshold may be determined according to (or based on) a value. The value can be configured by (or according to) RRC and/or MAC CE signaling. In some embodiments, the value may be configured by a channel quality parameter in the report and/or in a previous report. In some embodiments, the channel quality parameter may comprise at least one of a reference signal received power (RSRP), a signal-to-interference-plus-noise ratio (SINR), a channel quality indicator (CQI), a block error rate (BLER), and/or a bit error rate (BER). In some embodiments, the triggering condition may be determined according to (or based on) a channel quality parameter and/or a measurement result within a period. In some embodiments, a starting point of the period, and/or a length of period may be determined according to (or by using) a value. The value can be configured by (or according to) RRC and/or MAC CE signaling. In some embodiments, the period may be determined to be a maximum or minimum between a period of a DL RS of the plurality of DL RSs and a defined number of time units. In some embodiments, the period may be determined to be a shortest or longest period among DL RSs of the plurality of DL RSs.

Referring now to operation (1354), and in some embodiments, the wireless communication device may receive/obtain at least one of the plurality of DL RSs. Responsive to receiving the at least one of the plurality of DL RSs, the wireless communication device may send a report. The report may include/provide/specify/indicate time-difference information. The time difference information can include at least one of: a time difference between a receive timing and a transmit timing (or a time difference between a transmit timing and a receive timing), a reference signal time difference, a time difference between receive timing and reference timing, and/or a time difference between transmit timing and reference timing. In some embodiments, the time difference between receive timing and transmit timing may be defined/calculated/determined from the perspective of the wireless communication device. The time difference between receive timing and transmit timing may be defined as T_{UE-RX}−T_{UE-TX}, and/or defined as T_{UE-TX}−T_{UE-RX}. In some embodiments, T_{UE-RX} may be the receive timing in a DL time unit. In some embodiments, T_{UE-TX} may be the transmit timing in an uplink (UL) time unit. In some embodiments, the DL time unit may refer to (or specify/indicate) a time unit of receiving/obtaining a DL RS from the plurality of DL RSs. In some embodiments, the UL time unit may refer to (or specify/indicate) a time unit of transmitting/sending/communicating an UL RS. In some embodiments, T_{UE-RX} may be defined by a first detected path in time, and/or a path with strongest receive power in time. In some embodiments, the UL time unit may be closest in time to the DL time unit. In certain embodiments, the time difference between receive timing and transmit timing can be an important parameter for estimating the propagation time of a physical channel between the wireless communication node (e.g., TRP) and the wireless communication device (e.g., UE) from the perspective of the wireless communication node. For instance, the propagation time of the physical channel (e.g., a time of arrival) may be determined according to ((T_{TRP-RX}−T_{TRP-TX}) (T_{UE-RX}−T_{UE-TX}))/2. In some embodiments, T_{TRP-RX}−T_{TRP-TX} may denote a time difference between the transmit timing and the receive timing for the wireless communication node.

In some embodiments, the reference signal time difference (RSTD) may be defined/determined from the perspective of the wireless communication device, and/or defined/determined as T_{Rxj}−T_{Rxi}. In some embodiments, T_{Rxj} may be (or include/specify) a time at which the wireless communication device receives/obtains a first DL RS (e.g., DL RS/TRP j) and/or one time unit corresponding to (or associated with) the first DL RS. In some embodiments, T_{Rxi} may be a time when at which the wireless communication device receives/obtains a second DL RS (e.g., DL RS/TRP i) and/or one time unit corresponding to (or associated with) the second DL RS. In some embodiments, the time unit corresponding to (or associated with) the second DL RS may be nearest/closest in time to the time unit corresponding to the first DL RS. In some embodiments, the transmit timing may correspond to (or indicate) a time unit of transmitting/sending/communicating an uplink (UL) signal (e.g., from the perspective of the wireless communication device). In some embodiments, the receive timing may correspond to (or indicate) a time unit of receiving/obtaining the DL signal (e.g., from the perspective of the wireless communication device). In some embodiments, the reference timing may correspond to a reference time unit. In some embodiments, the time-difference information may be determined/generated using at least one of: a mod function, a scaling factor, a reference time unit, a timing advance value, the time difference between receive timing and transmit timing, the reference signal time difference, a time difference between receive timing and reference timing, a time difference between transmit timing and reference timing, and/or other information. In some embodiments, the time-difference information may be determined according to one of: (the reference time unit)−(the timing advance value)+(the time difference between receive timing and transmit timing), ((the time difference between receive timing and transmit timing)−(the timing advance value)) mod (the reference time unit), (the reference time unit)−(the timing advance value)*(the scaling factor)(the time difference between receive timing and transmit timing), and/or (the time difference between receive timing and transmit timing) mod (the reference time unit). In some embodiments, the scaling factor may be configured by (or by using) higher layer signaling, such as radio resource control (RRC) signaling and/or medium access control control element (MAC-CE) signaling. In some embodiments, the scaling factor may be ½, 1 or 2 (or other values). In some embodiments, the timing advance value may be configured by (or according to) RRC and/or MAC-CE signaling for uplink transmission timing adjustment.

Referring now to operation (1356), and in some embodiments, the wireless communication device may send/transmit/communicate a report/description. The wireless communication device mays send the report according to (or based on) the configuration. Responsive to the sending of the report, the wireless communication node may receive/obtain the report. In some embodiments, the report may include/provide/specify/indicate a timestamp and/or other information. The timestamp may comprises a time instance, a time unit, a symbol index, a slot index, a subframe index, a frame index, a transmission occasion index, and/or an indication of a time duration relative to the time instance associated with the report. For instance, the time duration may include or correspond to a number of time units/symbols/slots/subframes/frames/transmission occasions (e.g., before a report instance, or a report transmission). In some embodiments, at least one of: time-difference information, a Doppler shift, a Doppler spread, an average delay, a delay spread, a RS index, group information and/or a channel quality parameter, in the report, may be associated/related with and/or determined according to (or based on) the timestamp (e.g., the timestamp of the report).

In some embodiments, the report may include/provide/specify/indicate at least one of: an average delay, a delay spread, a Doppler shift, and/or a Doppler spread. The Doppler shift and/or the Doppler spread can be determined according to (or by using) a DL RS. The DL RS may refer/correspond to at least one DL RS of the plurality of DL RSs. In some embodiments, the DL RS may be reported/provided in the report. In some embodiments, the report may include/provide/specify at least one RS index. The at least one RS index may comprise at least one of: a RS resource index, a RS resource set index, a RS resource setting index, and/or a reporting configuration index. The at least one RS index may be associated/related with the timestamp, the time-difference information, the average delay, the delay spread, the Doppler shift, and/or the Doppler spread. In some embodiments, the time-difference information may comprise a time difference between receive timing and transmit timing, time difference between receive timing and reference timing, and/or time difference between transmit timing and reference timing. When the time-difference information comprises a time difference between receive timing and transmit timing, time difference between receive timing and reference timing, and/or time difference between transmit timing and reference timing, the time-difference information may be associated/related with one of the at least one RS index. In some embodiments, the time-difference information may comprise a reference signal time difference. When the time-difference information comprises a reference signal time difference, the time-difference information may be associated/related with more than one RS indexes of the at least one RS index. In some embodiments, more than one DL RS corresponding to the more than one RS indexes can be received/obtained simultaneously. In some embodiments, the more than one DL RS may be associated/related with same/corresponding group information. In some embodiments, the more than one DL RS (e.g., corresponding to the more than one RS indexes) may be received simultaneously and/or associated with different/separate/distinct group information.

In some embodiments, the report may include/specify/indicate N DL RSs. N may be a positive integer. In some embodiments, a DL RS with a best/optimum metric at a given timestamp may be reported/specified in the report. At least one of the N DL RSs can be associated with a timestamp. In some embodiments, the N DL RSs may be selected/identified from the plurality of DL RSs. The configuration can be configured by RRC and/or MAC-CE signaling (or other types of signaling). In some embodiments, a second RS in the report may be selected from the plurality of DL RSs. The second RS may be selected/identified according to (or based on) a first RS. The first RS may be included/specified/provided in a previous report, and/or in the report. In some embodiments, the first DL RS may be included/specified in the report. When the first DL RS is included in the report, the first DL RS may be associated/related with an earlier timestamp and/or associated with a smaller index corresponding to the timestamp. In some embodiments, an initial DL RS to be measured may be determined according to (or by using) a DL RS. The DL RS may be for determining a quasi co-location (QCL) assumption of a downlink data channel and/or a downlink control channel. In some embodiments, the initial DL RS may be configured by RRC or MAC-CE signaling. In some embodiments the initial DL RS may be (or correspond to) a DL RS with lowest or highest index (ID) in the pool (e.g., the plurality of DL RSs). In some embodiments, an association/relationship between the DL RS or its time unit, and/or the UL RS or its time unit, may be indicated/provided/specified by DCI, RRC, and/or MAC-CE signaling.

In some embodiments, a beam state may apply to the DL RS and/or the UL RS. In some embodiments, the UL RS may be associated/related with a same spatial relation and/or a same beam as the DL RS. In some embodiments, one DCI (e.g., a single DCI) may be to trigger transmission of the DL RS and/or the UL RS. In some embodiments, spatial relation and/or beam of the UL RS may be determined based on (or according to) the DL RS. In some embodiments, the configuration may be associated/related with a first reporting quantity. In some embodiments, a CSI request codepoint in the DCI may be associated with a resource set of the DL RS and a resource set of the UL RS, associated with both a CSI triggering state and an UL RS triggering state, and/or associated with both CSI triggering state and the resource set of the UL RS. In some embodiments, the CSI triggering state indicated by the DCI may be associated/related with a resource set. The resource set may comprise the UL RS. In some embodiments, at least one DL RS resource in the resource set of the DL RS may be quasi co-located (QCLed) and/or associated with a same transmission configuration indicator (TCI) state and/or a same quasi co-location (QCL) Type RS. In some embodiments, at least one UL RS resource in the resource set of the UL RS can be QCLed and/or associated with a same TCI state and/or same spatial relation. In some embodiments, the DL RS may comprise a DL RS resource set. In some embodiments, the UL RS may comprise one or more UL resource sets. At least one DL RS resource in the DL RS resource set can be divided/organized/partitioned into S DL RS resource subsets.

In some embodiments, the beam state may be indicated/specified/provided by the DCI, the MAC-CE and/or the RRC. In some embodiments, the DCI may comprise a plurality of DCI formats, such as DCI format 0_0, DCI format 0_1 and/or DCI format 0_2. In some embodiments, the time-difference information may be included/specified in the report. The report may be carried in an UL channel initialized by the DCI. In some embodiments, the DL RS may comprise a channel state information RS (CSI-RS) and/or other RSs. The CSI-RS may be associated/related with a repetition parameter and/or a trs-info parameter. In some embodiments, the UL RS may comprise/correspond to a sounding RS (SRS). In some embodiments, DL RS resource(s) in the DL RS resource subset may be QCLed and/or associated with a same TCI state and/or a same QCL-Type RS. In some embodiments, one of at least one UL RS resource set may be mapped/associated/linked with a DL RS resource subset. The one of at least one UL RS resource set can be mapped with a DL RS resource subset according to (or by using) DCI, MAC-CE and/or RRC signaling. In some embodiments, a spatial relation and/or path loss RS may be determined according to (or based on) an associated DL RS, an associated DL RS sub-group, and/or a DL RS or DL RS sub-group in the report. The spatial relation and/or path loss RS may correspond to the one of the at least one UL RS resource set. In some embodiments, the UL RS may not be configured with at least one of: a spatial relation and/or a path loss RS. In some embodiments, an association/relationship between a first DL RS or its time unit, and/or a second DL RS or its time unit, may be indicated/specified/provided by downlink control information (DCI), radio resource control (RRC) and/or medium access control control element (MAC-CE) signaling.

In some embodiments, a channel state information (CSI) request codepoint in the DCI may be associated/related with two or more DL RS resource groups. In some embodiments, the first DL RS may be selected/identified/determined from a first DL RS group. The second DL RS can be selected/identified from a second DL RS group. In some embodiments, one DCI can trigger the first DL RS and/or the second DL RS. In some embodiments, the configuration may be associated/related with a second reporting quantity. In some embodiments, DL RS resources in the first and/or second DL RS group can be quasi co-located (QCLed) and/or associated with a same beam and/or same quasi co-location (QCL) Type RS. In some embodiments, the DCI may comprise DCI format 0_0, DCI format 0_1 and/or DCI format 0_2. In some embodiments, the time-difference information may be included/specified/provided in the report. The report may be carried/communicated in an UL channel initialized by the DCI, the MAC-CE and/or the RRC. In some embodiments, the DL RS may comprise a channel state information RS (CSI-RS). The CSI-RS can be associated/related with a repetition parameter and/or a trs-info parameter (or other parameters).

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node, a configuration for a plurality of downlink (DL) reference signals (RSs);
receiving, by the wireless communication device, at least one of the plurality of DL RSs; and
sending, by the wireless communication device to the wireless communication node, a report.

2. The method of claim 1, wherein the report includes a timestamp, that comprises a time instance, a time unit, a symbol index, a slot index, a subframe index, a frame index, a transmission occasion index, or an indication of a time duration relative to the time instance associated with the report.

3. The method of claim 2, wherein at least one of: time-difference information, a Doppler shift, a Doppler spread, an average delay, a delay spread, a RS index, group information or a channel quality parameter, in the report, is associated with or determined according to the timestamp.

4. The method of claim 1, wherein the report includes time-difference information, that includes at least one of:
time difference between receive timing and transmit timing,
reference signal time difference,
time difference between receive timing and reference timing, or
time difference between transmit timing and reference timing.

5. The method of claim 4, wherein the time difference between receive timing and transmit timing is at least one of:
defined from perspective of the wireless communication device, or
defined as T_{UE-RX}−T_{UE-TX}, or defined as T_{UE-TX}−T_{UE-RX} where:
T_{UE-RX} is the receive timing in a DL time unit, and
T_{UE-TX} is the transmit timing in an uplink (UL) time unit.

6. The method of claim 5, wherein:
the DL time unit refers to a time unit of receiving a DL RS from the plurality of DL RSs,
the UL time unit refers to a time unit of transmitting an UL RS,
T_{UE-RX} is defined by a first detected path in time or a path with strongest receive power in time, or
the UL time unit is closest in time to the DL time unit.

7. The method of claim 4, wherein the reference signal time difference (RSTD) is at least one of:
defined from perspective of the wireless communication device, or
defined as T_{Rxj}−T_{Rxi}, or defined as T_{Rxi}−T_{Rxj}, where:
T_{Rxj} is a time at which the wireless communication device receives a first DL RS or one time unit corresponding to the first DL RS, and
T_{Rxi} is a time when at which the wireless communication device receives a second DL RS or one time unit corresponding to the second DL RS.

8. The method of claim 7, wherein the time unit corresponding to the second DL RS is nearest in time to the time unit corresponding to first DL RS.

9. The method of claim 4, wherein:
the transmit timing corresponds to a time unit of transmitting an uplink (UL) signal,
the receive timing corresponds to a time unit of receiving the DL signal, or
the reference timing corresponds to a reference time unit.

10. The method of claim 4, wherein the time-difference information is determined using at least one of: a mod function, a scaling factor, a reference time unit, a timing advance value, the time difference between receive timing and transmit timing, the reference signal time difference, time difference between receive timing and reference timing, or time difference between transmit timing and reference timing.

11. The method of claim 1, wherein the report includes at least one of: an average delay, a delay spread, a Doppler shift, or a Doppler spread, that is determined according to a DL RS that refers to at least one DL RS of the plurality of DL RSs or is reported in the report.

12. The method of claim 1, wherein the report includes at least one RS index that comprises at least one of: a RS resource index, a RS resource set index, a RS resource setting index, or a reporting configuration index, and the at least one RS index is associated with the timestamp, the time-difference information, the average delay, the delay spread, the Doppler shift, or the Doppler spread.

13. The method of claim 1, wherein the report includes group information that is associated with at least one of: a timestamp, a time-difference information, an average delay, a delay spread, a Doppler shift, or a Doppler spread.

14. The method of claim 1, wherein the report includes a channel quality parameter that comprises a reference signal received power (RSRP), a signal-to-interference-plus-noise ratio (SINR), a channel quality indicator (CQI), a precoding matrix indicator (PMI), a layer indicator (LI), or a rank indicator (RI).

15. The method of claim 1, wherein the report comprises uplink control information (UCI), channel state information (CSI) or a medium access control control element (MAC-CE).

16. The method of claim 1, comprising:
sending, by the wireless communication device to the wireless communication node, the report responsive to a triggering condition.

17. The method of claim 1, wherein the report includes N DL RSs, where N is a positive integer, and at least one of:
a DL RS with a best metric at a given timestamp is reported in the report, and one of N DL RSs is associated with a timestamp;
the N DL RSs are selected from the plurality of DL RSs, and the configuration is configured by radio resource control (RRC) or medium access control control element (MAC-CE) signaling; or
a second RS in the report is selected from the plurality of DL RSs according to a first RS that is included in a previous report, or is included in the report;

18. A method comprising:
sending, by a wireless communication node to wireless communication device, a configuration for a plurality of downlink (DL) reference signals (RSs), wherein the wireless communication device receives at least one of the plurality of DL RSs; and
receiving, by the wireless communication node from the wireless communication device, a report.

19. A wireless communication device comprising:
at least one processor configured to:
receive, via a transceiver from a wireless communication node, a configuration for a plurality of downlink (DL) reference signals (RSs);
receive, via the transceiver, at least one of the plurality of DL RSs; and
send, via the transceiver to the wireless communication node, a report.

20. A wireless communication node comprising:
at least one processor configured to:
send, via a transceiver to wireless communication device, a configuration for a plurality of downlink (DL) reference signals (RSs), wherein the wireless communication device receives at least one of the plurality of DL RSs; and
receive, via the transceiver from the wireless communication device, a report.
